(19) United States
(12) Patent Application Publication
(10) Pub. No.: US 2004/0220917 A1
(43) Pub. Date: Nov. 4, 2004

(54) SQL join elimination

(76) Inventors: Christopher Evans, Bristol (GB); Paolo Fragapane, Bristol (GB); Stephen Cave, Gloucester (GB); James Steadman, Bath (GB); Andrew Osborn, Bristol (GB); Kathryn Nash, Ledbury (GB)

Correspondence Address: SWIDLER BERLIN SHEREFF FRIEDMAN, LLP, 3000 K STREET, NW, BOX IP, WASHINGTON, DC, 20007, US

(21) Appl. No.: 10/673,140

(22) Filed: Sep. 30, 2003

(30) Foreign Application Priority Data
Apr. 30, 2003 (GB) 0309975.1

(51) Int. Cl. G06F 17/30

(52) U.S. Cl. 707/3

(57) ABSTRACT

A method of preventing execution of unnecessary joins between tables in a database is described.

A Structured Query Language (SQL) statement is presented to the database. The SQL statement has a scope that extends to a set of tables in the database and returns a set of results from the database.

A list of tables that are within the scope of the SQL statement but that are not referred to by the SQL statement is prepared.

Tables that must be accessed in order to return the set of results are removed from the list in accordance with a predetermined set of rules. The execution of joins involving any of the tables remaining in the list is prevented.

This invention relates to a method of preventing execution of unnecessary joins between tables in a database referred to by a Structured Query Language (SQL) statement.

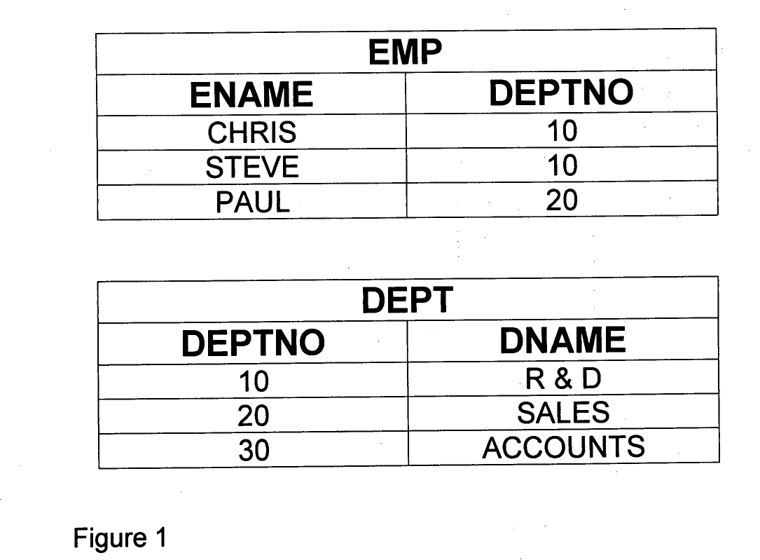

The concept of a join between tables in a database is well known. A simple example will be described here with reference to FIG. 1. This shows two tables with the names EMP and DEPT. The first table, EMP, lists the names of the employees of a company under the column ENAME against the number of the department for which they work under the column DEPTNO. The table DEPT has a similar column named DEPTNO in which each department number is only listed once and adjacent to this is a column entitled DESC giving the names of the respective departments. It can be seen that a many to one relationship exists between the tables EMP and DEPT via their respective DEPTNO columns. That is to say that a value in the DEPTNO column of DEPT can only appear once whilst the same value can appear many times in the DEPTNO column of EMP. In this context, table EMP is referred as the detail table and table DEPT is referred to as the master table.

The necessity for a join between these two tables comes about if, for example, it was desired to extract the names of the employees and their respective department names. A suitable structured query language (SQL) statement to perform this function is:

SELECT ENAME, DNAME FROM EMP, DEPT

WHERE EMP.DEPTNO=DEPT.DEPTNO

This statement informs the database that values in the DEPTNO column of table EMP can be considered equivalent to values in the DEPTNO column of table DEPT and allows it to return the results to the user, correctly indicating that Chris and Steve work in the R&D Department and that Paul works in the Sales Department.

Typically, a view is used to present the two joined tables to a user as a single table. For example, a view called EMPDEPT may be defined as the SQL statement given above. Subsequent SQL statements can then be executed that refer to the view EMPDEPT. For example, the SQL statement:

SELECT ENAME, DNAME FROM EMPDEPT

will return the same results as the previous SQL statement.

However, a problem exists in that, under certain circumstances, the join will be executed even though it is not needed. For example, the SQL statement:

SELECT ENAME FROM EMPDEPT

will still result in the join being executed although, in this instance, it is not necessary to execute the join to retrieve the desired data.

The execution of joins in situations such as this where they are unnecessary is extremely undesirable since they can be very costly in terms of processing speed, especially as the size of the database increases. Clearly, there exists a need for a method of preventing such unnecessary joins from being executed.

In accordance with a first aspect of the present invention, there is provided a method of preventing execution of unnecessary joins between tables in a database, the method comprising the steps of:

a. presenting a Structured Query Language (SQL) statement to the database, the SQL statement having a scope that extends to a set of tables in the database and returning a set of results from the database;

b. preparing a list of tables that are within the scope of the SQL statement but that are not referred to by the SQL statement;

c. removing tables that must be accessed in order to return the set of results from the list in accordance with a predetermined set of rules; and,

d. preventing execution of joins involving any of the tables remaining in the list.

Hence, this invention prevents the execution of unnecessary joins in a situation where an SQL statement includes one or more joins but the required data can be extracted from a subset of the joined tables. Prior to this invention, the join or joins would be executed irrespective of whether data was required from all tables or not.

Typically, the predetermined set of rules includes a rule allowing removal of a table from the list if this table is part of a join chain on a master table.

Normally, the predetermined set of rules includes a rule allowing removal of a table from the list if this table forms the detail table in a join between a master table and a detail table.

Typically, the predetermined set of rules includes a rule allowing removal of a table from the list if detail item values might not exist in a master table joined to a detail table.

Preferably, the predetermined set of rules includes a rule allowing removal of a table if that table has a mandatory filter.

In the event that the removal of a table from the list would normally be allowed since detail item values might not exist in a master table joined to a detail table or since that table has a mandatory filter then, preferably, the predetermined set of rules further includes a rule that prevents removal of a table from the list if the join is an outer join on a master table.

The invention will typically be provided as a computer program comprising computer program code means adapted to perform the steps of the first aspect of the invention when said program is run on a computer.

Further, there may be provided a computer program product comprising program code means stored on a computer readable medium for performing a method according to the first aspect of the invention when said program product is run on a computer.

An embodiment of the invention will now be described with reference to the accompanying drawings, in which:

FIG. 1 shows two tables in a database;

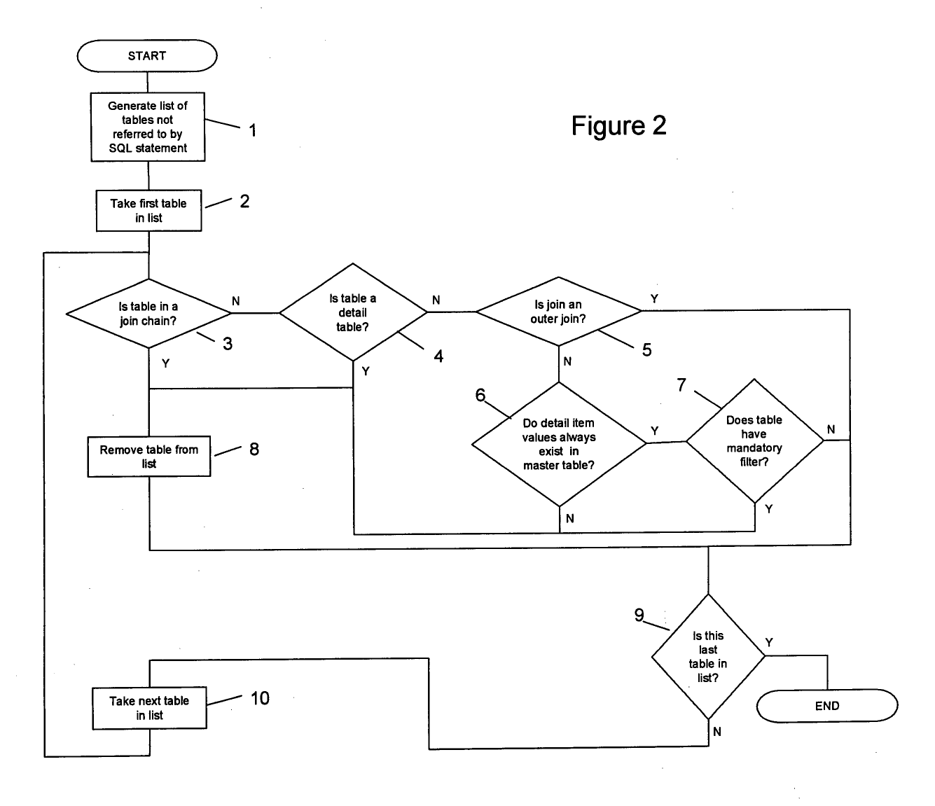

FIG. 2 shows a flowchart for a method according to the invention;

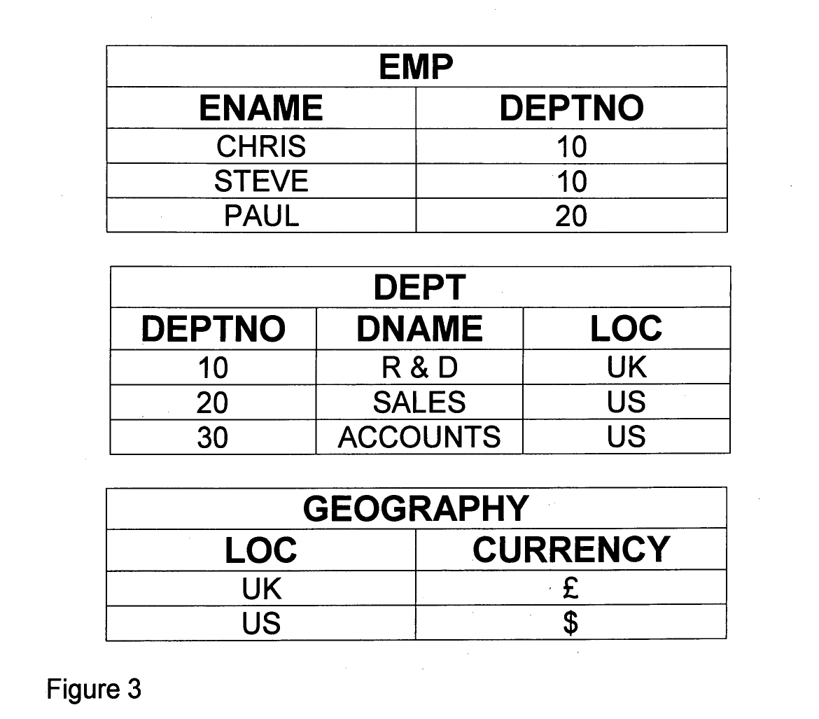

FIG. 3 shows three tables in a join chain; and,

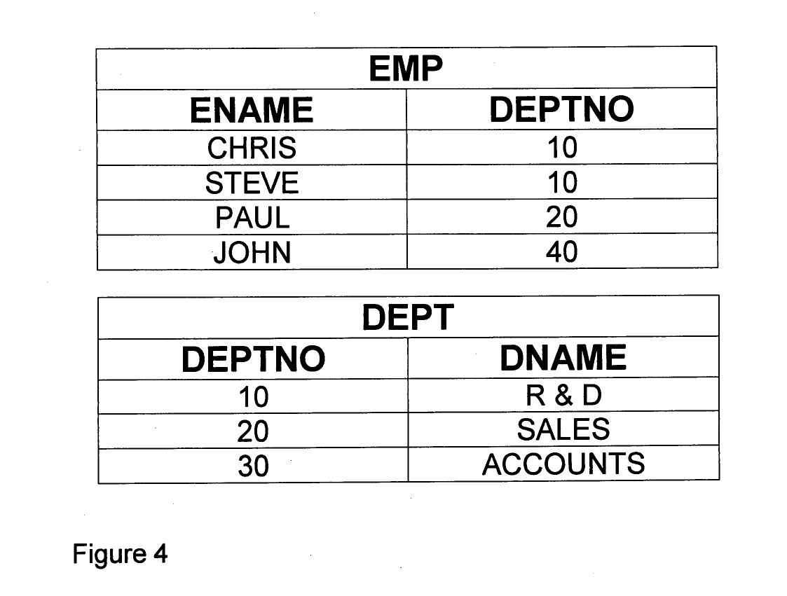

FIG. 4 shows a table in which not all of the detail item values exist in the master table.

As already mentioned, FIG. 1 shows two tables, EMP and DEPT, in a database. The tables are related by their respective DEPTNO columns. In order to simplify the presentation of information to a user, a view EMPDEPT may be defined as shown below:

SELECT ENAME, DNAME FROM EMP, DEPT

WHERE EMP.DEPTNO=DEPT.DEPTNO

In order to prevent the execution of unnecessary joins, the method shown in the flowchart in FIG. 2 is used. The first step 1 in this process generates a list of tables that are not referred to by an SQL statement but that are within its scope. For example, considering the view EMPDEPT already defined, the SQL statement:

SELECT ENAME FROM EMPDEPT

Both the tables EMP and DEPT are within the scope of the SQL statement although the statement only refers directly to the table EMP. It does not refer directly to the table DEPT. Hence, using the simple example shown in FIG. 1 having only these two tables and taking this SQL statement the list of tables will consist merely of DEPT. This can be considered to be a list of candidates for which it may be possible to prevent the execution of a join. In order to ascertain whether it is possible to prevent the execution of a join, the decision making steps 3 to 7 shown in FIG. 2 must be performed.

Step 2 of the process takes the first table from the list for processing by steps 3 to 7. In this example, this table is DEPT. This first table is then subjected to the decision making process of steps 3 to 7. These can be considered as a set of rules that must be satisfied in order for the table to remain in the list. Execution of a join involving any of the tables remaining in the list after the process has been completed will be prevented.

The first decision step 3 examines whether the table is part of a join chain. This concept is best described with respect to an example which is shown in FIG. 3. In this example, the tables EMP and DEPT have been set out as before although DEPT now has a further column known as LOC in which the location of each department is listed. A further table known as GEOGRAPHY has a corresponding LOC column and a CURRENCY column indicating the currency in use at that location. These tables may form a join chain in which the tables EMP and GEOGRAPHY are joined via table DEPT. For example, a view known as EMPDEPTLOC may be defined as:

SELECT ENAME, DNAME, CURRENCY

FROM EMP, DEPT, GEOGRAPHY

WHERE EMP.DEPTNO=DEPT.DEPTNO

AND DEPT.LOC=GEOGRAPHY.LOC

Then, the SQL statement:

SELECT ENAME, CURRENCY FROM EMPDEPTLOC

will return the following results:

| | |
|---|---|
| CHRIS | £ |
| STEVE | £ |
| PAUL | $ |

This statement does not directly refer to table DEPT and hence, table DEPT would be listed as a candidate for which a join need not be executed. However, if the join is not executed, this would lead to incorrect results since it is necessary to maintain the join chain between EMP and GEOGRAPHY through DEPT. Decision step 3 will determine that table DEPT is in a join chain and it will then be removed from the list in step 8, thereby ensuring that the join in the previous SQL statement will be executed. If, however, the table is not in a join chain the process continues to step 4.

Step 4 in the process is used to remove a table from the list if this table forms the detail table in a join between a master table and a detail table. That is to say that, if the join has a one to many or many to one relationship and the table is on the “many” end of the join then the table must be removed from the list so that the join is executed. The table on the “many” end of the join is known as the detail table whilst that on the “one” end of the join is the master table.

An example of a many to one relationship can be seen in FIG. 1 in which the column DEPTNO in table EMP has many instances of the value 10 for example whilst each value only appears once in column DEPTNO of table DEPT. This is a many to one join between these two tables in which DEPT is the master table and EMP is the detail table.

The SQL statement:

SELECT DNAME FROM EMPDEPT

should give the results shown below:

R&D

R&D

SALES

However, an incorrect implementation that eliminated the join between the two tables would give the following results:

R&D

SALES

ACCOUNTS

In accordance with step 4, if the table is a detail table in a join between the master table and the detail table, then it must be removed from the list and this is performed by step 8. If however this condition is not met then processing proceeds to step 5.

Step 5 is used to bypass steps 6 and 7 in the event that a join is an outer join.

An outer join is best described by way of example. The tables EMP and DEPT of FIG. 4 are similar to those of FIG. 1 except that a value of “JOHN” has been added under the column ENAME with a DEPTNO value of “40”. This value of 40 has no corresponding entry in the DEPT table but an outer join, as shown by the following SQL statement:

SELECT ENAME FROM EMPDEPT

where EMPDEPT is a view defined as:

SELECT ENAME, DNAME FROM EMPDEPT

WHERE EMP.DEPTNO=DEPT.DEPTNO (+)

will still return the value of “JOHN”.

The outer join operator “(+)” informs the database to return the value of JOHN even though he has no department. An outer join returns all rows from the table without the outer join operator for which there are no matching rows in a table with the outer join operator.

If the join is an outer join then step 5 determines that it is not necessary to proceed with steps 6 and 7 and the table is not removed from the list by step 8, processing proceeding instead to step 9.

The next step 6 determines whether detail item values always exist in a master table joined to a detail table or otherwise. For example, considering FIG. 4 again, EMP is a detail table joined to a master table DEPT. If detail item values must always exist in the master table, then the join between EMP and DEPT need not be executed for the SQL statement:

SELECT ENAME FROM EMPDEPT

However, if detail item values might not exist in the master table, as is shown in FIG. 4, then the join must be executed and the table is removed from the list by step 8.

If processing proceeds to step 7 then this step determines whether the table has a mandatory filter attached to it. For example, this filter might be used to return results for a query to the ENAME column only where the corresponding DNAME value is SALES.

In order to implement this mandatory filter, a view known as EMPDEPTSALES may be defined as:

SELECT ENAME, DNAME FROM EMP, DEPT

WHERE EMP.DEPTNO=DEPT.DEPTNO

AND DNAME!=‘SALES’

The mandatory filter is invoked by the “DNAME!=‘SALES’” fragment of this definition. In the SQL statement:

SELECT ENAME FROM EMPDEPTSALES

the join cannot be removed because of the mandatory filter on table DEPT.

If the table does have a mandatory filter then the join must be executed and the table is removed from the list by step 8. Otherwise, if there is no mandatory filter, then the join can be removed and the table remains in the list.

In any event, processing eventually proceeds to step 9 as shown in FIG. 2 which determines if the current table is the last table in the list. If it is not then processing proceeds to step 10 which takes the next table from the list and returns to step 3 to consider this next table. If, however, this is the last table then the process ends.

Execution of a join will be prevented if that join involves any of the tables remaining in the list after proceeding through the flowchart shown in FIG. 2.

It is important to note that while the present invention has been described in a context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links.

We claim:

1. A method of preventing execution of unnecessary joins between tables in a database, the method comprising the steps of:
a. presenting a Structured Query Language (SQL) statement to the database, the SQL statement having a scope that extends to a set of tables in the database and returning a set of results from the database;
b. preparing a list of tables that are within the scope of the SQL statement but that are not referred to by the SQL statement;
c. removing tables that must be accessed in order to return the set of results from the list in accordance with a predetermined set of rules; and,
d. preventing execution of joins involving any of the tables remaining in the list.

2. A method according to claim 1, wherein the predetermined set of rules includes preventing removal of a table from the list if this table is part of a join chain.

3. A method according to claim 1, wherein the predetermined set of rules includes a rule allowing removal of a table from the list if this table forms the detail table in a join between a master table and a detail table.

4. A method according to claim 1, wherein the predetermined set of rules includes a rule allowing removal of a table from the list if detail item values might not exist in a master table joined to a detail table.

5. A method according to claim 1, wherein the predetermined set of rules includes a rule allowing removal of a table from the list if that table has a mandatory filter.

6. A method according to claim 4, wherein the predetermined set of rules further includes a rule preventing removal of a table from the list that would otherwise be allowed, if the join is an outer join on a master table.

7. A method according to claim 5, wherein the predetermined set of rules further includes a rule preventing removal of a table from the list that would otherwise be allowed, if the join is an outer join on a master table.

8. A computer program comprising computer program code means adapted to perform the steps of claim 1 when said program is run on a computer.

9. A computer program product comprising program code means stored on a computer readable medium for performing the method of claim 1 when said program product is run on a computer.
